(19) United States
(12) Patent Application Publication
(10) Pub. No.: US 2009/0124753 A1
(43) Pub. Date: May 14, 2009

(54) Crosslinkable Substances Based on Organosilicon Compounds

(75) Inventor: Marko Prasse, Glaubitz (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/817,441

(22) PCT Filed: Feb. 23, 2006
(86) PCT No.: PCT/EP2006/001653

§ 371 Date: Aug. 30, 2007

(30) Foreign Application Priority Data
Mar. 3, 2005 (DE) 10 2005 009 783.9

(51) Int. Cl. C08L 83/05

(52) U.S. Cl. 524/588; 525/478

(57) ABSTRACT

Crosslinkable compositions especially useful as one component sealants include a basic nitrogen compound and an oxathiazine or derivative thereof as an antimicrobial. Despite the presence of the basic nitrogen compound, the compositions are resistant to coloration both before and after cure, while yet exhibiting antimicrobial activity.

The invention relates to crosslinkable substances based on organosilicon compounds comprising oxathiazines and/or the derivatives thereof, in particular 3-(benzo[b]thien-2-yl)-5,6-dihydro-1,4,2-oxathiazine 4-oxide, to processes for the preparation thereof and to the use thereof.

Single-component sealants which are storable with the exclusion of water and which vulcanize on admission of water at ambient temperature to give elastomers are well known. These products are used in large amounts, for example in the construction industry. A growth with organisms such as fungi or also algae is readily formed on the surface of the sealants, in particular in surroundings of high atmospheric humidity, such as, for example, in bathrooms or kitchens, but also, for example, tropical regions. In order to prevent this, fungicides which prevent the growth are added to the sealants.

On the other hand, components made of plastics, such as PVC or acrylates, are increasingly frequently being used in the above-mentioned applications. In order to achieve satisfactory adhesion to these components, adhesives with groups exhibiting basic nitrogen are added to the sealants used. This further restricts the already small number of fungicides which can be used since the frequently used fungicides N-octyl-4-isothiazolin-3-one and 4,5-dichloro-2-(n-octyl)-4-isothiazolin-3-one result, in the simultaneous presence of basic nitrogen, in marked discoloration of the sealants. Moreover, some fungicides are cleaved by the basic nitrogen, with the result that they are no longer effective.

Other standard fungicides, such as methyl benzimidazol-2-yl-carbamate (carbendazim), 10,10′-oxybisphenoxarsine, 2-(4-thiazolyl)benzimidazole, diiodomethyl p-tolyl sulfone (Amical, cf., e.g., EP 34 877 A), triazolyl compounds, such as tebuconazole, in combination with silver-comprising zeolites (cf., e.g., EP 931 811 A and EP 640 661 A), and benzothiophene-2-cyclohexylcarboxamide S,S-dioxide, likewise in some cases have serious disadvantages, such as content of toxic heavy metals, chemical instability, tendency to discoloration, prohibition in some countries or markets, lack of commercial availability or high cost.

A subject matter of the invention is crosslinkable substances based on organosilicon compounds which comprise oxathiazines and/or the derivatives thereof as well as compounds exhibiting basic nitrogen.

The crosslinkable substances are preferably substances which can be crosslinked by a condensation reaction.

In the context of the present invention, the term “condensation reaction” is obviously intended to concomitantly encompass an optionally preceding hydrolysis stage.

In the context of the present invention, the term “condensable radicals” is also intended to mean those radicals which concomitantly include an optionally preceding hydrolysis stage.

The substances according to the invention are particularly preferably those comprising
(A) organosilicon compound with at least two condensable groups,
(B) oxathiazines and/or the derivatives thereof, if appropriate
(C) crosslinking agent and
(D) compounds exhibiting basic nitrogen.

The organosilicon compounds used and which participate in the crosslinking reaction may exhibit any group as the condensable groups, such as hydroxyl, oximato and organyloxy groups, in particular alkoxy radicals, such as ethoxy radicals, alkoxyethoxy radicals and methoxy radicals.

The organosilicon compounds (A) used according to the invention can be all organosilicon compounds with at least two condensable groups which have also been used hitherto in substances crosslinkable by the condensation reaction. In this connection, both pure siloxanes, thus ≡Si—O—Si≡ structures, and silcarbanes, thus ≡Si—R″—Si≡ structures with R″ the same as a divalent hydrocarbon radical which is optionally substituted or interrupted by heteroatoms, or any copolymer exhibiting organosilicon groups, may be involved.

The organosilicon compounds (A) used according to the invention are preferably those comprising units of the formula

Rₐ(OR¹)_{b}Y_{c}SiO_{(4-a-b-c)/2} (I),

in which
R can be identical or different and represents optionally substituted hydrocarbon radicals which can be interrupted by oxygen atoms,
R¹ can be identical or different and represents a hydrogen atom or monovalent optionally substituted hydrocarbon radicals which can be interrupted by oxygen atoms,
Y can be identical or different and represents a halogen atom, a pseudohalogen radical, Si—N-bonded amine radicals, amide radicals, oxime radicals and aminoxy radicals,
a is 0, 1, 2 or 3, preferably 1 or 2,
b is 0, 1, 2 or 3, preferably 0, 1 or 2, particularly preferably 0, and
c is 0, 1, 2 or 3, preferably 0 or 1, particularly preferably 0,
   with the proviso that the sum of a+b+c is less than or equal to 4 and at least two condensable radicals (OR¹) are present per molecule.

Preferably, the sum a+b+c is less than or equal to 3.

Radical R is preferably monovalent hydrocarbon radicals with 1 to 18 carbon atoms which are optionally substituted by halogen atoms, amino groups, ether groups, ester groups, epoxy groups, mercapto groups, cyano groups or (poly)glycol radicals, the latter being formed from oxyethylene and/or oxypropylene units, particularly preferably alkyl radicals with 1 to 12 carbon atoms, in particular the methyl radical. Radical R can, however, also be divalent radicals which, e.g., bond two silyl groups to one another.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl or tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl and methylcyclohexyl radicals; alkenyl radicals, such as the vinyl, 1-propenyl and 2-propenyl radical; aryl radicals, such as the phenyl, naphthyl, anthryl and phenanthryl radicals; alkaryl radicals, such as o-, m- and p-tolyl radicals, xylyl radicals and ethylphenyl radicals; and aralkyl radicals, such as the benzyl radical, the α-phenylethyl radical and the β-phenylethyl radical.

Examples of substituted radicals R are the methoxyethyl, the ethoxyethyl and the ethoxyethoxyethyl radical.

Examples of divalent radicals R are polyisobutylenediyl radicals and propanediyl-terminated polypropylene glycol radicals.

Examples of radicals R¹ are the monovalent radicals given for R.

The radical R¹ is preferably a hydrogen atom or alkyl radicals with 1 to 12 carbon atoms, particularly preferably the hydrogen atom, a methyl radical or an ethyl radical, in particular the hydrogen atom.

Examples of radicals Y are the dimethylamino, cyclohexylamino and methylethylketoximo radical.

Organosilicon compounds (A) used according to the invention are particularly preferably those of the formula

(OR¹)_{3-f}R_{f}Si—(SiR₂—O)ₑ—SiR_{f}(OR^{l})_{3-f} (II),

in which
R and R¹ have one of the meanings given above,
e is equal to 30 to 3000 and
f is equal to 1 or 2.

Preferably, f is equal to 2 if R¹ has the meaning of a hydrogen atom and f is equal to 1 if R¹ has a meaning other than a hydrogen atom.

Examples of organosilicon compounds (A) are

(MeO)₂MeSiO[SiMe₂O]₂₀₀₋₂₀₀₀SiMe(OMe)₂,

(HO)Me₂SiO[SiMe₂O]₂₀₀₋₂₀₀₀SiMe₂(OH),

(EtO)₂MeSiO[SiMe₂O]₂₀₀₋₂₀₀₀SiMe(OEt)₂,

(HO)MeViSiO[SiMe₂O]₂₀₀₋₂₀₀₀SiMeVi(OH),

(MeO)₂ViSiO[SiMe₂O]₂₀₀₋₂₀₀₀SiVi(OMe)₂ and

(EtO)₂ViSiO[SiMe₂O]₂₀₀₋₂₀₀₀SiVi(OEt)₂,

Me representing the methyl radical, Et representing the ethyl radical and Vi representing the vinyl radical.

The organosilicon compounds (A) used according to the invention have a viscosity of preferably 100 to 10⁶ mpa·s, particularly preferably of 10³ to 350 000 mpa·s, in each case at 25° C.

The organosilicon compounds (A) are commercially available products or can be prepared according to methods common in silicon chemistry.

The component (B) used according to the invention preferably concerns oxathiazines and/or the derivatives thereof of the general formula (III)

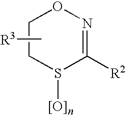

in which
R² represents an aromatic radical,
R³ represents a hydrogen atom or a monovalent, optionally substituted, hydrocarbon radical and
n is 0, 1 or 2.

Examples of radicals R² are the phenyl, naphthyl, pyridinyl, thienyl, furanyl and benzo[b]thien-2-yl radical, which can optionally be substituted.

The radical R² preferably concerns benzo[b]thien-2-yl, 4-chlorophenyl or 2-thienyl radicals.

Examples of radicals R³ are the hydrogen atom, hydrocarbon radicals with 1 to 4 carbon atoms and the benzyl radical, the hydrogen atom being preferred.

Examples of the oxathiazines and/or the derivatives thereof used according to the invention are 3-(benzo[b]thien-2-yl)-5,6-dihydro-1,4,2-oxathiazine 4-oxide, 3-(4-chlorophenyl)-5,6-dihydro-1,4,2-oxathiazine 4,4-dioxide and 5,6-dihydro-3-(2-thienyl)-1,4,2-oxathiazine 4-oxide, 3-(benzo[b]thien-2-yl)-5,6-dihydro-1,4,2-oxathiazine 4-oxide being particularly preferred.

Oxathiazines and/or the derivatives thereof (B) are commercially available products or can be prepared according to methods common in organic chemistry. Reference may be made for this, for example, to EP-A 715 495, in which 3-(benzo[b]thien-2-yl)-5,6-dihydro-1,4,2-oxathiazine 4-oxide is described.

The substances according to the invention comprise component (B) in amounts from preferably 0.01 to 3 parts by weight, particularly preferably from 0.1 to 1 part by weight, in particular from 0.2 to 0.4 part by weight, in each case based on 100 parts by weight of organosilicon compound (A).

The crosslinking agents (C) optionally used in the substances according to the invention may concern any crosslinking agent known hitherto with at least three condensable radicals, such as, for example, silanes or siloxanes with at least three organyloxy groups.

The crosslinking agents (C) optionally used in the substances according to the invention are preferably organosilicon compounds of the formula

(R⁵O)_{d}Z_{g}SiR⁴_{(4-d-g)} (V),

in which
R⁴ can be identical or different and represents monovalent, optionally substituted, hydrocarbon radicals which can be interrupted by oxygen atoms,
R⁵ can be identical or different and has a meaning mentioned above for R¹,
Z can be identical or different and has a meaning given for Y,
d is 0, 1, 2, 3 or 4, preferably 2 or 3, particularly preferably 3, and
g is 0, 1, 2, 3 or 4, preferably 0 or 3, particularly preferably 0,
   with the proviso that the sum d+g is equal to 3 or 4, and also the partial hydrolysates thereof.

In this connection, the partial hydrolysates can be partial homohydrolysates, i.e. partial hydrolysates of a type of organosilicon compound of the formula (V), and also partial cohydrolysates, i.e. partial hydrolysates of at least two different types of organosilicon compounds of the formula (V).

If the crosslinking agent (C) optionally used in the substances according to the invention concerns partial hydrolysates of organosilicon compounds of the formula (IV), those with up to 6 silicon atoms are preferred.

Examples of radical R⁵ are the examples mentioned above for radical R¹. Radical R⁶ preferably concerns a hydrogen atom and alkyl radicals, particularly preferably a hydrogen atom and alkyl radicals with 1 to 4 carbon atoms, in particular the hydrogen atom, the methyl radical and the ethyl radical.

Examples of radical R⁴ are the monovalent examples mentioned above for radical R, hydrocarbon radicals with 1 to 12 carbon atoms being preferred and the methyl radical and the vinyl radical being particularly preferred.

Examples of Z are the examples given for Y, methylethylketoximo radicals being preferred.

The crosslinking agents (C) optionally used in the substances according to the invention are particularly preferably tetramethoxysilane, tetraethoxysilane, tetrapropoxysilane, tetrabutoxysilane, methyltrimethoxysilane, methyltriethoxysilane, vinyltrimethoxysilane, vinyltriethoxysilane, phenyltrimethoxysilane, phenyltriethoxysilane, 3-cyanopropyltrimethoxysilane, 3-cyanopropyltriethoxysilane, 3-(glycidoxy)-propyltriethoxysilane, 1,2-bis(trimethoxysilyl)ethane, 1,2-bis-(triethoxysilyl)ethane, methyltris(methylethylketoximo)silane, vinyltris(methylethylketoximo)silane, tetrakis-(methylethylketoximo)silane and also partial hydrolysates of the organosilicon compounds mentioned, such as, e.g. hexaethoxydisiloxane.

The crosslinking agents (C) optionally used in the substances according to the invention are commercially available products or can be prepared according to processes known in silicon chemistry.

If the substances according to the invention comprise crosslinking agent (C), the amounts concerned are from preferably 0.01 to 20 parts by weight, particularly preferably from 0.5 to 10 parts by weight, in particular from 1.0 to 5.0 parts by weight, in each case based on 100 parts by weight of organopolysiloxane (A).

The compounds (D) exhibiting basic nitrogen used according to the invention are preferably those chosen from the group consisting of compounds of the formula

NR⁶₃ (VI)

in which R⁶ can be identical or different and represents a hydrogen atom or hydrocarbon radicals which are optionally substituted by hydroxyl groups, halogen atoms, amino groups, ether groups, ester groups, epoxy groups, mercapto groups, cyano groups or (poly)glycol radicals, the latter being formed from oxyethylene and/or oxypropylene units,
with the proviso that, in formula (VI), at the most two R⁶ have the meaning of a hydrogen atom,
cyclic aliphatic amines, such as, for example, piperidine and morpholine,
and also organosilicon compounds with at least one organic radical exhibiting basic nitrogen of units of formula

R⁷ₖAₗSi(OR⁸)ₘO_{(4-k-l-m)/2} (VII),

in which
R⁷ can be identical or different and represents a monovalent SiC-bonded organic radical which does not comprise basic nitrogen,
R⁸ can be identical or different and has a meaning given for radical R¹,
A can be identical or different and represents a monovalent SiC-bonded radical with basic nitrogen,
k is 0, 1, 2 or 3,
l is 0, 1, 2, 3 or 4 and
m is 0, 1, 2 or 3,
   with the proviso that the sum of k+l+m is less than or equal to 4 and at least one radical A is present per molecule.

Examples of radical R⁶ and R⁷ are, in each case independently of one another, the examples given for R for optionally substituted hydrocarbon radicals.

The optionally substituted hydrocarbon radicals R⁶ are preferably those with 1 to 18 carbon atoms.

Radical R⁷ preferably concerns hydrocarbon radicals with 1 to 18 carbon atoms, the methyl radical, the ethyl radical and the n-propyl radical being particularly preferred, especially the methyl radical.

Examples of radical R⁸ are the examples given for radical R¹.

Radical R⁸ is preferably the hydrogen atom, the methyl radical and the ethyl radical.

Examples of radicals A are radicals of the formulae H₂NCH₂—, H₂N(CH₂)₂—, H₂N(CH₂)₃—, H₂N(CH₂)₂NH(CH₂)₂—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, H₃CNH(CH₂)₂—, C₂H₅NH(CH₂)₂—, H₂N(CH₂)₄—, H₂N(CH₂)₅—, H(NHCH₂CH₂)₃—, C₄H₉NH(CH₂)₂NH(CH₂)₂—, cyclo-C₆H₁₁NH(CH₂)₃—, cyclo-C₆H₁₁NH(CH₂)₂—, (CH₃)₂N(CH₂)₃—, (CH₃)₂N(CH₂)₂—, (C₂H₅)₂N(CH₂)₃— and (C₂H₅)₂N(CH₂)₂—.
A is preferably a H₂N(CH₂)₃—, H₂N(CH₂)₂NH(CH₂)₃—, H₃CNH(CH₂)₃—, C₂H₅NH(CH₂)₃— and cyclo-C₆H₁₁NH(CH₂)₃ radical, the H₂N(CH₂)₂NH(CH₂)₃— radical and the cyclo-C₆H₁₁NH(CH₂)₃ radical being particularly preferred.

If the organosilicon compounds of units of the formula (VII) are silanes, then k is preferably 0, 1 or 2, particularly preferably 0 or 1, l is preferably 1 or 2, particularly preferably 1, and m is preferably 1, 2 or 3, particularly preferably 2 or 3, with the proviso that the sum of k+l+m is equal to 4.

Examples of the silanes of the formula (VII) optionally used according to the invention are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₃—Si(OH)₃, H₂N(CH₂)₂NH(CH₂)₃—Si(OH)₂CH₃, H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH (CH₂)₃—Si(OC₂H₅)₂CH₃, cyclo-C₆H₁₁NH(CH₂)₃—Si(OH)₃, cyclo-C₆H₁₁NH(CH₂)₃—Si(OH)₂CH₃, HN((CH₂)₃—Si(OCH₃)₃)₂ and HN((CH₂)₃—Si(OC₂H₅)₃)₂ and also the partial hydrolysates thereof, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₃—Si(OH)₃, H₂N(CH₂)₂NH(CH₂)₃—Si(OH)₂CH₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H₅)₂CH₃, cyclo-C₆H₁₁NH(CH₂)₃—Si(OH)₃ and also cyclo-C₆H₁₁NH(CH₂)₃—Si(OH)₂CH₃ being preferred and H₂N(CH₂)₂NH(CH₂)₃—Si(OCH₃)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OCH₃)₂CH₃, H₂N(CH₂)₂NH(CH₂)₃—Si(OH)₃ and H₂N(CH₂)₂NH(CH₂)₃—Si(OH)₂CH₃ and also in each case the partial hydrolysates thereof being particularly preferred.

If the organosilicon compound of units of the formula (VII) concerns organopolysiloxanes, the average value of k is preferably between 0.5 and 2.5, particularly preferably between 1.4 and 2.0, the average value of l is preferably between 0.01 and 1.0, particularly preferably between 0.01 and 0.6, and the average value of m is preferably between 0 and 2.0, particularly preferably between 0 and 0.2, with the proviso that the sum of k, l and m is less than or equal to 3.

The organopolysiloxanes of units of the formula (VII) which can be used according to the invention have a viscosity at 25° C. from preferably 5 to 10⁵ mpa·s, particularly preferably from 10 to 10₄ mpa·s.

Examples of the organopolysiloxanes of units of the formula (VII) which can be used according to the invention are H₂N(CH₂)₃—Si(OCH₃)₂—O—Si(CH₃)(OCH₃)₂, H₂N(CH₂)₃—Si(OC₂H₅)₂—O—Si(CH₃)(OCH₃)₂, H₂N(CH₂)₃—Si(OC₂H₅)₂—O—Si(CH₃)(OC₂H₅)₂, H₂N(CH₂)₃—Si(OCH₃)(CH₃)—O—Si(CH₃)(OCH₃)₂, H₂N(CH₂)₃—Si(OCH₃)(CH₃)—O—Si(OCH₃)₃, H₂N(CH₂)₃—Si(OC₂H₅)(CH₃)—O—Si(OCH₃)₃, H₂N(CH₂)₂NH(CH₂)₃—Si(OCH₃)₂—O—Si(CH₃)(OCH₃)₂, H₂N(CH₂)₂NH(CH₂)₃—Si(OC₂H₅)₂—O—Si(CH₃)(OCH₃)₂, H₂N(CH₂)₂NH(CH₂)₃—Si(OC₂H₅)₂—O—Si(CH₃)(OC₂H₅)₂, H₂N(CH₂)₂NH(CH₂)₃—Si(OCH₃)(CH₃)—O—Si (CH₃)(OCH₃)₂, H₂N(CH₂)₂NH(CH₂)₃—Si(OCH₃)(CH₃)—O—Si(OCH₃)₃, H₂N(CH₂)₂NH(CH₂)₃—Si(OC₂H₅)(CH₃)—O—Si(OCH₃)₃, cyclo-C₆H₁₁NH(CH₂)₃—Si(OCH₃)₂—O—Si(CH₃)(OCH₃)₂, cyclo-C₆H₁₁NH(CH₂)₃—Si(OC₂H₅)₂—O—Si(CH₃)(OCH₃)₂, cyclo-C₆H₁₁NH(CH₂)₃—Si(OC₂H₅)₂—O—Si(CH₃)(OC₂H₅)₂, cyclo-C₆H₁₁NH(CH₂)₃—Si(OCH₃)(CH₃)—O—Si(CH₃)(OCH₃)₂, cyclo-C₆H₁₁NH(CH₂)₃—Si(OCH₃)(CH₃)—O—Si(OCH₃)₃ and cyclo-C₆H₁₁NH(CH₂)₃—Si(OC₂H₅)(CH₃)—O—Si (OCH₃)₃, H₂N(CH₂)₃—Si(OCH₃)₂—(O—Si(CH₃)₂)₁₋₁₀₀—O—Si(OCH₃)₂—(CH₂)₃ NH₂, H₂N(CH₂)₂NH(CH₂)₃—Si(OCH₃)₂—(O—Si(CH₃)₂)₁₋₁₀₀—O—Si(OCH₃)₂—(CH₂)₃—NH(CH₂)₂NH₂ and cyclo-C₆H₁₁NH(CH₂)₃—Si(OCH₃)₂—(O—Si(CH₃)₂)₁₋₁₀₀—O—Si(OCH₃)₂—(CH₂)₃ NH—cyclo-C₆H₁₁ and also the partial hydrolysates thereof, particular preference being given to H₂N(CH₂)₃—Si(OC₂H₅)₂—O—Si(CH₃)(OC₂H₅)₂.

Organosilicon compounds of units of the formula (VII) are commercially available products or can be prepared according to processes common in silicon chemistry.

Examples of amines of the formula (VI) are cyclohexylamine, triethylamine, trioctylamine, butylamine, dodecylamine, diethyl(n-propyl)amine, cyclohexylmethylamine, 2-aminoethanol, 2-amino-n-propanol, 2-amino-2-methyl-1-propanol, 2-dimethylamino-2-methyl-1-propanol, N,N-diethylethanolamine, ethylenediamine, coconut fatty amine, coconut fatty methylamine, N,N-dimethylethanolamine and aniline.

The component (D) preferably concerns organosilicon compounds of units of the formula (VII).

For the preparation of the composition according to the invention, component (D) is preferably used in such an amount that the content of basic nitrogen is preferably from 0.01 to 5 parts by weight, particularly preferably from 0.01 to 1 part by weight, especially from 0.04 to 0.5 part by weight, in each case based on 100 parts by weight of organosilicon compound (A).

In addition to the components (A), (B), (C) and (D) described above, the substances according to the invention can comprise all additional substances which have also been used hitherto in substances which can be crosslinked by a condensation reaction, such as, e.g., catalysts (E), plasticizers (F), fillers (G), adhesives (H) and additives (I).

Examples of catalysts (E) are all catalysts which are also used hitherto in substances which can be crosslinked by a condensation reaction. Examples of catalysts (E) are titanium compounds and organotin compounds, such as di(n-butyl)tin dilaurate and di(n-butyl)tin diacetate, di(n-butyl)tin oxide, dioctyltin diacetate, dioctyltin dilaurate, dioctyltin oxide and reaction products of these compounds with alkoxysilanes, such as tetraethoxysilane, di(n-butyl)tin diacetate and dibutyltin oxide in tetraethyl silicate hydrolysate being preferred and di(n-butyl)tin oxide in tetraethyl silicate hydrolysate being particularly preferred.

If the substances according to the invention comprise catalyst (E), amounts from preferably 0.01 to 3 parts by weight, preferably from 0.05 to 2 parts by weight, in each case based on 100 parts by weight of constituent (A), are concerned.

Examples of plasticizers (F) are dimethylpolysiloxanes end-blocked by trimethylsiloxy groups which are liquid at ambient temperature, in particular with viscosities at 25° C. in the range between 50 and 1000 mpa·s, and also high boiling point hydrocarbons, such as, for example, paraffin oils or mineral oils consisting of naphthene and paraffin units.

The substances according to the invention comprise plasticizers (F) in amounts from preferably 0 to 300 parts by weight, particularly preferably from 10 to 200 parts by weight, in particular from 20 to 100 parts by weight, in each case based on 100 parts by weight of organopolysiloxane (A).

Examples of fillers (G) are nonreinforcing fillers, thus fillers with a BET surface of up to 50 m²/g, such as quartz, diatomaceous earth, calcium silicate, zirconium silicate, zeolites, metal oxide powders, such as aluminum, titanium, iron or zinc oxides or the mixed oxides thereof, barium sulfate, calcium carbonate, gypsum, silicon nitride, silicon carbide, boron nitride, glass and plastic powders, such as polyacrylonitrile powder; reinforcing fillers, thus fillers with a BET surface of more than 50 m²/g, such as pyrogenic silica, precipitated silica, precipitated calcium carbonate, carbon black, such as furnace black and acetylene black, and silicon/aluminum mixed oxides with a large BET surface; fibrous fillers, such as asbestos, and also plastic fibers. The fillers mentioned can be rendered hydrophobic, for example by treatment with organosilanes or organosiloxanes or with stearic acid or by etherification of hydroxyl groups to give alkoxy groups. If fillers (G) are used, they are preferably hydrophilic pyrogenic silica and precipitated or ground calcium carbonate.

The substances according to the invention comprise fillers (G) in amounts from preferably 0 to 300 parts by weight, particularly preferably from 1 to 200 parts by weight, in particular from 5 to 200 parts by weight, in each case based on 100 parts by weight of organopolysiloxane (A).

Examples of the adhesives (H) used in the substances according to the invention are silanes and organopolysiloxanes with functional groups, such as, for example, those with glycidoxypropyl or methacryloyloxypropyl radicals and also tetraalkoxysilanes. If, however, another component, such as, for example, siloxane (A) or crosslinking agent (C) or amine (D), already exhibits the functional groups mentioned, an addition of adhesive may be dispensed with.

The substances according to the invention comprise adhesives (H) in amounts from preferably 0 to 50 parts by weight, particularly preferably from 1 to 20 parts by weight, in particular from 1 to 10 parts by weight, in each case based on 100 parts by weight of organopolysiloxane (A).

Examples of additives (I) are pigments, dyes, fragrances, oxidation inhibitors, agents for influencing the electrical properties, such as conductive blacks, flame retardants, light stabilizers, agents for extending the skinning time, such as silanes with an SiC-bonded mercaptoalkyl radical, cell-generating agents, e.g. azodicarbonamide, heat stabilizers, scavengers, such as Si—N-comprising silazanes or silylamides, cocatalysts, such as Lewis and Bronsted acids, e.g. sulfonic acids, phosphoric acids, phosphoric acid esters, phosphonic acids and phosphonic acid esters, and thixotropic agents, such as, for example, phosphoric acid esters or polyglycols, and organic solvents, such as alkylaromatic compounds.

The substances according to the invention comprise additives (I) in amounts from preferably 0 to 100 parts by weight, particularly preferably from 0 to 30 parts by weight, in particular from 0 to 10 parts by weight, in each case based on 100 parts by weight of organopolysiloxane (A).

The substances according to the invention are especially preferably those which consist of
(A) organosilicon compounds comprising units of the formula (I),
(B) oxathiazines and/or the derivatives thereof of the formula (III),
   if appropriate
(C) crosslinking agents of the formula (V),
(D) compounds exhibiting basic nitrogen,
   if appropriate
(E) catalyst,
   if appropriate
(F) plasticizers,
   if appropriate
(G) fillers,
   if appropriate
(H) adhesives and
   if appropriate
(I) additives.

The substances according to the invention are preferably viscous to pasty substances.

On contact with a dampened universal indicator paper (e.g. universal indicator from Merck, Germany, with a measurement range from pH 1-14), the substances according to the invention have a pH of preferably 7 to 12, particularly preferably of 9 to 11.

All constituents can be mixed with one another in any sequence for the preparation of the substances according to the invention. This mixing can be carried out at ambient temperature and atmospheric pressure, thus approximately from 900 to 1100 hPa. If desired, this mixing can, however, also be carried out at higher temperatures, e.g. at temperatures in the range from 35° C. to 135° C. Furthermore, it is possible, for a while or continuously, to mix under reduced pressure, such as, e.g., at from 30 to 500 hPa absolute pressure, in order to remove volatile compounds or air.

Individual constituents of the substances according to the invention can in each case be one type of such a constituent as well as also a mixture of at least two different types of such constituents.

The usual water content of the air is sufficient for the crosslinking of the substances according to the invention. The crosslinking of the substances according to the invention is preferably carried out at ambient temperature. It can, if desired, also be carried out at higher or lower temperatures than ambient temperature, e.g. at from −5° C. to 15° C. or at from 30° C. to 50° C. and/or by means of water concentrations exceeding the normal water content of the air.

Preferably, the crosslinking is carried out at a pressure from 100 to 1100 hPa, in particular at atmospheric pressure, thus approximately from 900 to 1100 hPa.

An additional subject matter of the present invention are molded articles prepared by crosslinking the substances according to the invention.

The substances according to the invention can be used for all purposes for which substances which are storable with the exclusion of water and which crosslink on admission of water at ambient temperature to give elastomers can be used.

The substances according to the invention are accordingly excellently suitable, for example, as sealants for joints, including vertical joints, and similar empty spaces from, e.g., 10 to 40 mm in width, e.g. of buildings, land vehicles, watercraft and aircraft, or as adhesives or putties, e.g. in the construction of windows or in the manufacture of glass cabinets, and also, e.g., for the preparation of protective coatings, including those for surfaces exposed to the constant action of fresh or seawater, or antislip coatings, or of elastomeric molded articles, and also for the insulation of electrical or electronic equipment.

The substances according to the invention have the advantage that they are easy to prepare and show biocidal action over a long period of time.

Furthermore, the substances according to the invention have the advantage that, through the provision of biocide, the tendency to discolor, both of the yet uncured substance and of the cured molded articles, is extremely low.

The crosslinkable substances according to the invention have the advantage that they are distinguished by a very high storage stability and a high crosslinking rate.

In the examples described below, all viscosity data refer to a temperature of 25° C. Unless otherwise stated, the following examples are carried out at atmospheric pressure, thus approximately at 1000 hPa, and at ambient temperature, thus at approximately 23° C., or at a temperature which appears while mixing the reactants at ambient temperature without additional heating or cooling, and also at a relative humidity of approximately 50%. Furthermore, all data for parts and percentages, insofar as not otherwise stated, refer to the weight.

### EXAMPLE 1

A fungicide paste was prepared by dispersing 30 parts of 3-(benzo[b]thien-2-yl)-5,6-dihydro-1,4,2-oxathiazine 4-oxide in 70 parts of a polydimethylsiloxane end-blocked by trimethylsilyl and with a viscosity of 1000 mPa·s.

330 g of a polydimethylsiloxane mixture, in which the siloxanes are terminated with dimethoxymethylsilyl and/or dimethoxyvinylsilyl groups and the ratio of dimethoxymethylsilyl end groups to dimethoxyvinylsilyl end groups is approximately 1:1, with a viscosity of 80 000 mpa·s, 265 g of a polydimethylsiloxane end-blocked by trimethylsilyl with a viscosity of 1000 mPa·s, 14 g of methyltrimethoxysilane, 12.5 g of an adhesive, prepared by reaction of 1 part of aminopropyltriethoxysilane with 1 part of methyltriethoxysilane hydrolysate with an ethoxy content of 37%, and 4.5 g of aminopropyltrimethoxysilane are mixed together in a planetary mixer and stirred for 15 minutes. The batch is subsequently brought to completion by homogeneously mixing in 63 g of pyrogenic silica with a specific surface of 150 m²/g, 1.1 g of octylphosphonic acid, 1.4 g of a polyethylene glycol/polypropylene glycol copolymer with a viscosity of 700 mpa·s, 2.5 g of a tin catalyst, prepared by reaction of di(n-butyl)tin diacetate and tetraethoxysilane, and 1.64 g of the fungicide paste described above. Finally, the air which has been mixed in is removed by stirring at approximately 100 hPa for 5 minutes.

The substance thus obtained is stable, colorless and translucent and has, on contact with a dampened universal indicator paper from Merck (measurement range pH 1-14), a pH of 10.

The substance thus obtained was charged to an aluminum tube, subjected to an airtight seal and stored at 70° C. After 7 days, the test sample was applied in a thickness of 2 mm to a PE sheet and stored at 23° C./50% relative humidity. The test sample showed a normal curing behavior and not the slightest discoloring.

The cured rubber showed a good fungicidal action against all types of fungi stipulated in ISO 846.

### EXAMPLE 2

300 g of a polydimethylsiloxane with hydroxydimethylsilyl end groups and a viscosity of 80 000 mPa·s, 200 g of a polydimethylsiloxane end-blocked by trimethylsilyl with a viscosity of 1000 mPa·s, 38.5 g of methyltris(methylethylketoximo)silane and 7.0 g of vinyltris(methylethylketoximo)silane are mixed with one another in a planetary mixer and stirred for 10 minutes, then 7.0 g of aminopropyltriethoxysilane are added and the mixture is stirred for a further 3 minutes. The batch is subsequently brought to completion by homogeneously mixing in 48 g of pyrogenic silica with a specific surface of 150 m²/g, 400 g of a ground and surface-coated calcium carbonate with a mean particle diameter of 5.7 μm (available commercially from Omya GmbH, Cologne, Germany, under the description “Omya BLR 3”), 2.3 g of the fungicide paste described in example 1 and 0.9 g of di(n-butyl)tin diacetate. Finally, the air mixed in is removed by stirring at approximately 100 hPa for 5 minutes.

The substance thus obtained is stable and white and has, on contact with a dampened universal indicator paper from Merck (measurement range pH 1-14), a pH of 10.

The substance thus obtained was charged to an aluminum tube, subjected to an airtight seal and stored at 70° C. After 7 days, the test sample was applied in a thickness of 2 mm to a PE sheet and stored at 23° C./50% relative humidity. The test sample showed a normal curing behavior and not the slightest discoloring.

The cured rubber showed a good fungicidal action against all types of fungi stipulated in ISO 846.

1.-10. (canceled)

11. A crosslinkable substance based on organosilicon compounds which comprises at least one oxathiazine or derivative thereof, and at least one compound containing basic nitrogen.

12. The crosslinkable substance of claim 11 which can be crosslinked by a condensation reaction.

13. The crosslinkable substance of claim 11 comprising
(A) at least one organosilicon compound with at least two condensable groups,
(B) at least one oxathiazine or a derivative thereof,
(C) optionally, one or more crosslinking agents, and
(D) at least one compound containing basic nitrogen.

14. The crosslinkable substance of claim 11 wherein the organosilicon compounds (A) comprise units of the formula
Rₐ(OR¹)_{b}Y_{c}SiO_{(4-a-b-c)/2} (I),
in which
R each can be identical or different and is an optionally substituted hydrocarbon radical optionally interrupted by oxygen atoms,
R¹ each can be identical or different and is a hydrogen atom or monovalent optionally substituted hydrocarbon radical optionally interrupted by oxygen atoms,
Y each can be identical or different and is a halogen atom, a pseudohalogen radical, Si—N-bonded amine radical, amide radical, oxime radical or aminoxy radical,
a is 0, 1, 2 or 3,
b is 0, 1, 2 or 3 and
c is 0, 1, 2 or 3,
with the proviso that the sum of a+b+c is less than or equal to 4 and at least two condensable radicals (OR1) are present per molecule.

15. The crosslinkable substance of claim 11, wherein component (B) comprises a compound of the formula (III) 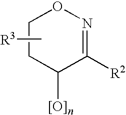
in which
R² is an aromatic radical,
R³ is a hydrogen atom or a monovalent, optionally substituted hydrocarbon radical, and
n is 0, 1 or 2.

16. The crosslinkable substance of claim 11, wherein component (B) comprises 3-(benzo[b]thien-2-yl)-5,6-dihydro-1,4,2-oxathiazine 4-oxide.

17. The crosslinkable substance of claim 11, wherein component (B) is present in amounts from 0.01 to 3 parts by weight, based on 100 parts by weight of organosilicon compound (A).

18. The crosslinkable substance of claim 11, wherein component (D) is present in an amount such that the content of basic nitrogen is from 0.01 to 5 parts by weight, based on 100 parts by weight of organosilicon compound (A).

19. The crosslinkable substance of claim 11 consisting essentially of
(A) organosilicon compound(s) comprising units of the formula (I),
(B) at least one oxathiazine or derivative thereof of the formula (III),
(C) optionally, crosslinking agent(s) of the formula (V),
(D) at least one compound containing basic nitrogen,
(E) optionally, catalyst(s),
(F) optionally, plasticizer(s),
(G) optionally, filler(s),
(H) optionally, adhesion promoter(s), and
(I) optionally, further additives other than (A) through (H).

20. A molded article, prepared by crosslinking a crosslinkable substance of claim 11.
